(19) United States
(12) Patent Application Publication
(10) Pub. No.: US 2023/0388932 A1
(43) Pub. Date: Nov. 30, 2023

(54) RADIO COMMUNICATION NODE

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/031,753

(22) PCT Filed: Oct. 15, 2020
(86) PCT No.: PCT/JP2020/038958

§ 371 Date: Apr. 13, 2023

(51) Int. Cl. H04W 52/08

(52) U.S. Cl. CPC H04W 52/08

(57) ABSTRACT

A radio communication node (100 B) receives a plurality of control parameters of transmission power of a radio signal to an upper node, and controls transmission power by using any of the control parameters based on a transmission/reception pattern of the radio signal with a child node.

### TECHNICAL FIELD

The present disclosure relates to a radio communication node configuring radio access and radio backhaul.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, an NR radio access network (RAN) specifies Integrated Access and Backhaul (IAB) that integrates radio access to a terminal (User Equipment, UE) and a radio backhaul between radio communication nodes such as a radio base station (gNB) (see Non-Patent Literature 1)

In IAB, an IAB node has a Mobile Termination (MT) function for connecting to a parent node (which may be referred to as an IAB donor) and a Distributed Unit (DU) function for connecting to a child node or UE.

IAB also supports simultaneous transmission and reception using a time division return signal (TDD) between a radio link (Link_parent) between a parent node and an IAB node, that is, MT and a radio link (Link_child) between an IAB node and a child node, that is, DU.

### CITATION LIST

### Non-Patent Literature

[Non-Patent Literature 1]

3GPP TS 38.213 V 16.1.0, 3rd Generation Partnership Project; Technical Specification Group Radio Access Network; NR; Physical layer procedures for control (Release 16), 3GPP, March 2020

### SUMMARY OF INVENTION

However, the realization of simultaneous transmission and reception in the MT and DU as described above has the following problems. Specifically, when the MT (Hereinafter abbreviated as IAB-MT) of the IAB node and the DU (Hereinafter abbreviated as IAB-DU) of the IAB node simultaneously perform transmission, since the IAB-DU corresponding to the radio base station generally has a larger transmission power than the IAB-MT, when the parent node receives the radio signal transmitted from the IAB-MT, the radio signal transmitted from the IAB-DU may cause interference.

Accordingly, the following disclosure has been made in view of such a situation, and it is an object of the invention to provide a radio communication node capable of surely avoiding interference from a DU of an IAB node in a parent node.

One aspect of the present disclosure is a radio communication node (radio communication node 100 B) including a reception unit (control signal processing unit 140) that receives a plurality of control parameters of transmission power of a radio signal to an upper node (For example, radio communication node 100 A), and a control unit (control unit 170) that controls the transmission power using any of the control parameters based on a transmission/reception pattern of a radio signal with a child node (For example, radio communication node 100 C or UE 200).

One aspect of the present disclosure is a radio communication node (radio communication node 100 B) including a reception unit (control signal processing unit 140) that receives a plurality of control parameters of transmission power of a radio signal to an upper node (For example, radio communication node 100 A), and a control unit (control unit 170) that controls the transmission power using any of the control parameters based on a transmission/reception pattern of a radio signal with a child node (For example, radio communication node 100 C or UE 200).

### BRIEF DESCRIPTION OF DRAWINGS

FIG. 1 is an overall schematic configuration diagram of radio communication system 10.

FIG. 2 is a diagram showing a basic configuration example of the IAB.

FIG. 3 is a functional block diagram of the radio communication node 100 B (IAB node).

FIG. 4 is a diagram showing an example of interference to UL transmission by DL transmission of the IAB-DU.

FIG. 5 shows an example in which the IAB-MT performs UL transmission at low power.

FIG. 6 is a diagram showing an example of a communication sequence for UL power control of the IAB-MT.

FIG. 7 is a diagram showing a configuration example of PUSCH-ConfigCommon (part).

FIG. 8 is a diagram showing a configuration example of PUCCH-ConfigCommon (part).

FIG. 9 is a diagram showing a configuration example of a part of PUSCH-ConfigCommon including p0-NominalWithGrant.

FIG. 10 is a diagram showing an example of a hardware configuration of the radio communication nodes 100 A to 100 C.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

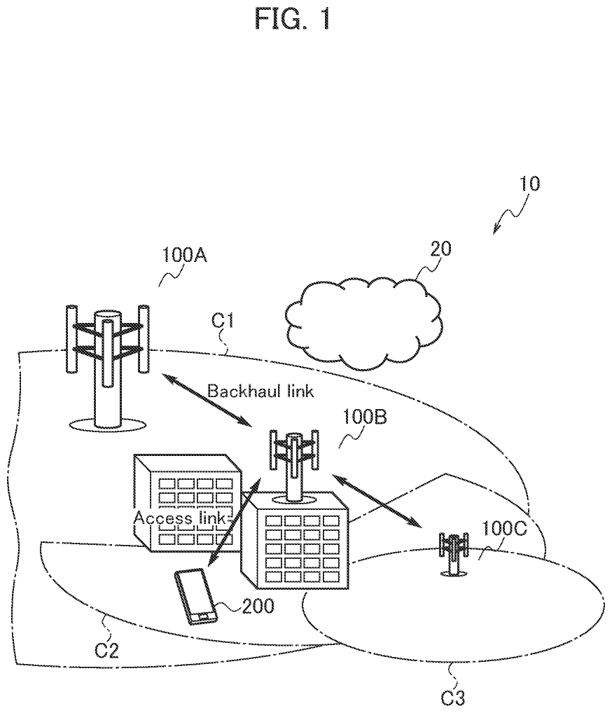

FIG. 1 is an overall schematic configuration diagram of a radio communication system 10 according to this embodiment. The radio communication system 10 is a radio communication system in accordance with 5G New Radio (NR) and comprises a plurality of radio communication nodes and terminals. The radio communication system 10 may be a radio communication system that follows a scheme called Beyond 5G, 5G Evolution or 6G.

Specifically, radio communication system 10 includes a Next Generation-Radio Access Network 20 (NG-RAN 20, radio communication nodes 100 A, 100 B, 100 C, and terminal 200 (UE 200, User Equipment).

The radio communication nodes 100 A, 100 B and 100 C can form cells C1, C2 and C3, respectively. The radio communication nodes 100 A, 100 B, 100 C can configure a radio access (access link) with the UE 200 and a radio backhaul (backhaul link) between the radio communication nodes via the cell. Specifically, a radio link backhaul (transmission path) may be configured between the radio communication node 100 A and the radio communication node 100 B, and between the radio communication node 100 B and the radio communication node 100 C.

Thus, a configuration in which radio access with the UE 200 and a radio backhaul between the radio communication nodes are integrated is called Integrated Access and Backhaul (IAB).

The IAB reuses existing functions and interfaces defined for radio access. In particular, Mobile-Termination (MT), gNB-DU (Distributed Unit), gNB-CU (Central Unit), User Plane Function (UPF), Access and Mobility Management Function (AMF) and Session Management Function (SMF) and corresponding interfaces such as NR Uu (between MT and gNB/DU), F1, NG, X2 and N4 may be used as baselines.

The radio communication node 100 A is connected to the NG-RAN 20 and the core network (Next Generation Core (NGC) or 5 GC) via a wired transmission line such as a fiber transport. NG-RAN and NGC may be included and simply referred to as “network”.

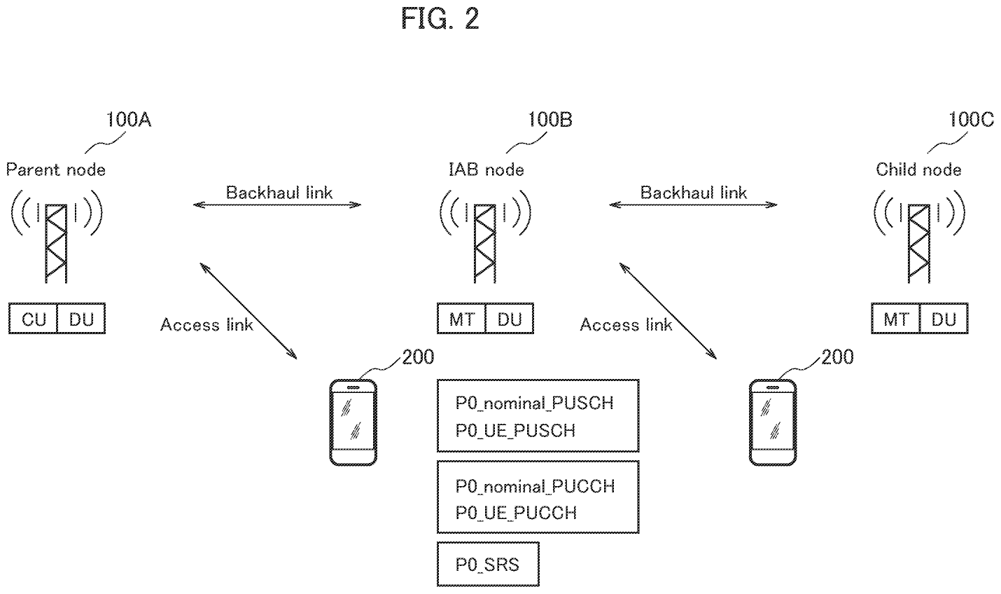

FIG. 2 is a diagram showing a basic configuration example of the IAB. As shown in FIG. 2, in this embodiment, radio communication node 100 A may constitute an IAB donor in IAB, and radio communication node 100 B (and radio communication node 100 C) may constitute an IAB node in IAB.

The IAB donor may be referred to as an upper node in relation to the IAB node. In addition, the IAB donor may be referred to as a parent node. Also, the IAB donor may have a CU, and the parent node may be used simply as a name in relation to the IAB node (or child node) and may not have a CU. The IAB node may be referred to as a subordinate node in relation to the IAB donor (parent node). The child node may include the UE 200.

A backhaul link is established between the IAB donor and the IAB node. Specifically, a radio link called Link_parent may be configured. A radio link (Backhaul link) is configured between the IAB node and the child node. Specifically, a radio link called Link_child may be configured.

The link_parent may consist of a DL Parent BH in the downward direction and a UL Parent BH in the upward direction. The Link_child may comprise DL Child BH in the downward direction and UL Child BH in the upward direction.

The IAB node has a Mobile Termination (IAB-MT) function for connecting to the IAB donor and a Distributed Unit (IAB-DU) function for connecting to the child node (or UE 200). The child node also has an MT and a DU. The IAB donor has a Central Unit (CU) and a DU.

In terms of radio resources used by the DU, downlink (DL), uplink (UL) and flexible time-resource (D/U/F) are classified into any type of hard, soft or not available (H/S/NA). In Soft (S), available or not available is also defined.

Flexible time-resource (F) is a radio resource (time resource and/or frequency resource) that can be used for either DL or UL. “Hard” is a radio resource whose corresponding time resource is always available for a DU child link connected to a child node or UE, and “Soft” is a radio resource (DU resource) whose availability of the corresponding time resource for a DU child link is explicitly or implicitly controlled by an IAB donor (or parent node).

In addition, if it is Soft (S), the radio resource to be notified can be determined based on IA or INA.

IA means that the DU resource is explicitly or implicitly indicated as available. Also, “INA” means that the DU resource is explicitly or implicitly indicated as unavailable.

In this embodiment, the radio access and the radio backhaul may be half-duplex or full-duplex. Time division multiplexing (TDM), space division multiplexing (SDM) and frequency division multiplexing (FDM) are available as multiplexing methods.

When an IAB node operates in half-duplex communication, DL Parent BH is on the receiving (RX) side, UL Parent BH is on the transmitting (TX) side, DL Child BH is on the transmitting (TX) side, and UL Child BH is on the receiving (RX) side. In the case of the time division duplex (TDD), the setting pattern of DL/UL in the IAB node is not limited to DL-F-UL only, and only the radio backhaul (BH), a setting pattern such as UL-F-DL may be applied. In this embodiment, SDM/FDM is used to realize simultaneous operation of DU and MT of the IAB node.

### (2) Function Block Configuration of Radio Communication System

Next, the functional block configuration of radio communication system 10 will be described. Specifically, the functional block configurations of the radio communication nodes 100 A, 100 B, and 100 C constituting the IAB node will be described.

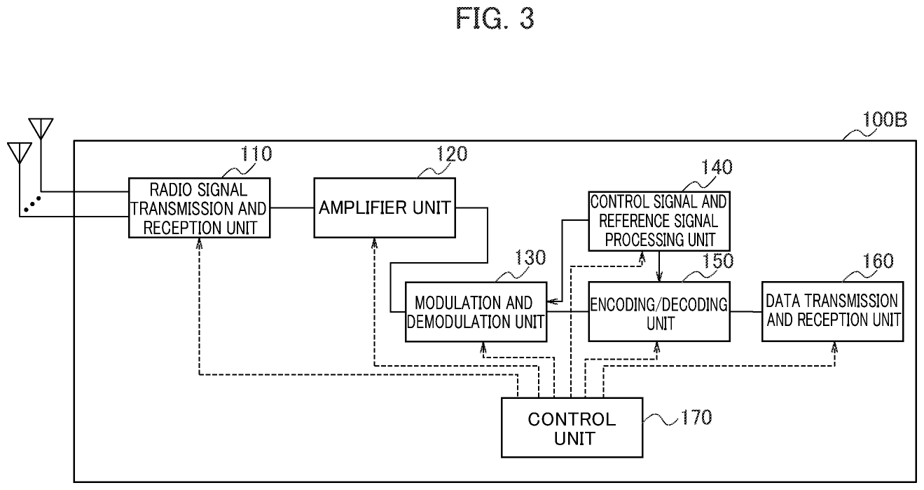

FIG. 3 is a functional block diagram of the radio communication node 100 B (IAB node). The radio communication node 100 A differs from the radio communication node 100 B that functions as an IAB node in that it functions as an IAB donor (parent node). The radio communication node 100 C is different from the radio communication node 100 B in that it functions as a child node. Hereinafter, the case of the radio communication node 100 B will be described as an example.

As shown in FIG. 3, the radio communication node 100 B includes a radio signal transmission and reception unit 110, an amplifier unit 120, a modulation and demodulation unit 130, a control signal processing unit 140, an encoding/decoding unit 150, and a control unit 170.

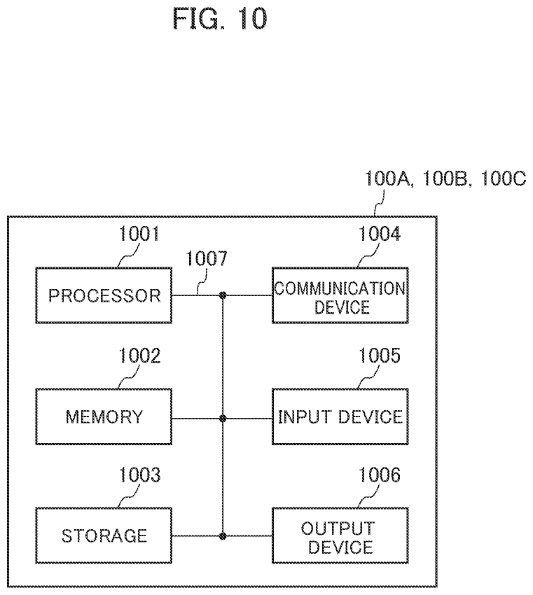

Note that FIG. 5 shows only the main functional blocks associated with the description of the embodiment, and the radio communication node 100 B has other functional blocks (For example, the power supply section, etc.). FIG. shows a functional block configuration of the radio communication node 100 B, and refer to FIG. 10 for a hardware configuration.

The radio signal transmission and reception unit 110 transmits and receives radio signals in accordance with NR. By controlling radio (RF) signals transmitted from multiple antenna elements, radio signal transmission and reception unit 110 can support Massive MIMO for generating more directional beams, Carrier Aggregation (CA) for bundling multiple component carriers (CCs), and Dual Connectivity (DC) for simultaneously communicating between the UE and each of the two NG-RAN Nodes.

The radio signal transmission and reception unit 110 can transmit and receive radio signals to and from the radio communication node 100 A via the cell C1. The radio signal transmission and reception unit 110 can also transmit and receive a radio signal to and from the radio communication node 100 C or the UE 200 via the cell C2.

The amplifier unit 120 is composed of a PA (Power Amplifier)/LNA (Low Noise Amplifier) and the like. The amplifier unit 120 amplifies the signal output from the modulation and demodulation unit 130 to a predetermined power level. The amplifier unit 120 also amplifies the RF signal output from the radio signal transmission and reception unit 110.

The modulation and demodulation unit 130 performs data modulation/demodulation, transmission power setting, resource block allocation and the like for each specific communication destination (Radio communication node 100 A, 100 B or UE 200).

The control signal processing unit 140 executes processing related to various control signals transmitted and received by the radio communication node 100 B. Specifically, the control signal processing unit 140 receives various control signals transmitted from the radio communication node 100 A (or radio communication node 100 C) and the UE 200 via the control channel, for example, a control signal of the radio resource control layer (RRC). The control signal processing unit 140 transmits various control signals to the radio communication node 100 A or the UE 200 via the control channel.

Further, the control signal processing unit 140 can execute processing using a reference signal (RS) such as a demodulation reference signal (DMRS) and a phase tracking reference signal (PTRS).

The DMRS is a reference signal (pilot signal) known between a base station and a terminal of each terminal for estimating a fading channel used for data demodulation. The PTRS is a reference signal for each terminal for the purpose of estimating phase noise which becomes a problem in a high frequency band.

In addition to the DMRS and PTRS, the reference signal may include a Channel State Information-Reference Signal (CSI-RS), a Sounding Reference Signal (SRS), and a Positioning Reference Signal (PRS) for position information.

The channel includes a control channel and a data channel. The control channels include PDCCH (Physical Downlink Control Channel), PUCCH (Physical Uplink Control Channel), PRACH (Physical Random Access Channel), PBCH (Physical Broadcast Channel), and the like.

The data channels include PDSCH (Physical Downlink Shared Channel) and PUSCH (Physical Uplink Shared Channel). The signals may include channel and reference signals.

In this embodiment, the control signal processing unit 140 can receive the control parameter of the transmission power of the radio signal to the upper node from the network. Specifically, the control signal processing unit 140 can receive a plurality of control parameters of the transmission power of the IAB-MT for transmitting a radio signal to the radio communication node 100 A (upper node). In the present embodiment, the control signal processing unit 140 constitutes a reception unit for receiving a plurality of control parameters of transmission power.

The transmission power control parameters of the IAB-MT may be interpreted as uplink (UL) power control parameters. The control signal processing unit 140 can receive 2 sets of power control parameters having different set values. The power control parameter can be interpreted as being configured for the IAB-MT.

One of the two sets of power control parameters may be applied when simultaneous transmission and reception (or alternatively, simultaneous transmission) between the IAB-MT and the IAB-DU is performed, and the other may be applied when no such simultaneous transmission and reception is performed.

More specifically, the transmission power of the IAB-MT may be switched based on the two sets of power control parameters according to the pattern (DL or UL transmission) of the time division return signal (TDD) of the child node (which may include the UE 200).

The two sets of power control parameters may be, for example, any combination of the following.
P0_nominal_PUSCH
P0_UE_PUSCH
P0_nominal_PUCCH
P0_UE_PUCCH
P0_SRS

These power control parameters may be included in PUSCH-ConfigCommon and PUCCH-ConfigCommon as defined in 3GPP TS 38.331. Details of the power control parameters will be described later.

The control signal processing unit 140 can receive a plurality of pieces of identification information for closed-loop power control of the radio signal to the upper node. In the present embodiment, the control signal processing unit 140 constitutes a reception unit for receiving the identification information of the closed loop power control.

Specifically, the control signal processing unit 140 can receive the closed loop index (Specifically, closed loop index 1), which is the identification information (index) of the closed loop power control. The identification information may be interpreted as an index of a transmit power control (TPC) command with closed loop power control.

The identification information may be explicitly notified by the downlink control information (DCI), for example, or may be implicitly notified based on other notified information (For example, Identifier for DCI formats).

The control signal processing unit 140 can transmit to the network capability information indicating the capability to control the transmission power or to cope with the closed-loop power control. In this embodiment, the control signal processing unit 140 constitutes a transmission unit for transmitting capability information.

Specifically, the control signal processing unit 140 may transmit the transmission power of the radio signal transmitted by the IAB-MT, that is, the capability information indicating whether or not the transmission power control of the radio signal to the upper node including the parent node is applicable. The capability information may be interpreted as UE capability information specified in 3GPP TS 38.331 or the like.

The encoding/decoding unit 150 performs data division/connection, channel coding/decoding, and the like for each predetermined communication destination (radio communication node 100 A or UE 200).

Specifically, encoding/decoding unit 150 divides the data output from the data transmission and reception unit 160 into predetermined sizes, and executes channel coding on the divided data. The encoding/decoding unit 150 decodes the data output from the modulation and demodulation unit 130 and concatenates the decoded data.

The data transmission and reception unit 160 transmits and receives protocol data units (PDU) and service data units (SDU). Specifically, the data transmission and reception unit 160 performs assembly/disassembly of PDUs/SDUs in a plurality of layers (Media access control layer (MAC), radio link control layer (RLC), and packet data convergence protocol layer (PDCP), etc.).

The control unit 170 controls each function block constituting the radio communication node 100 B. In particular, in this embodiment, the control unit 170 executes control concerning simultaneous transmission and reception between the IAB-MT and the IAB-DU.

Specifically, the control unit 170 can control the transmission power of a radio signal from the IAB-MT depending on whether the IAB-MT and the IAB-DU perform simultaneous transmission and reception. More specifically, the control unit 170 can control the transmission power using any control parameter based on the transmission/reception pattern of the radio signal with the child node. One of the control parameters may be a power control parameter (P0_nominal_PUSCH, P0_UE_PUSCH, P0_nominal_PUCCH, P0_UE_PUCCH, P0_SRS) received by the control signal processing unit 140.

Of these power control parameters, the control unit 170 may use different power control parameters depending on the presence or absence of simultaneous transmission/reception between the IAB-MT and the IAB-DU. That is, the control unit 170 may switch the transmission power of the IAB-MT depending on whether the transmission/reception pattern (which may be read as the TDD pattern) of the child node is DL or UL transmission.

Also, the control unit 170 can execute the closed loop power control associated with any identification information of the closed loop power control based on the transmission/reception pattern of the radio signal with the child node. The identification information may be identification information (For example, closed loop index 1) of closed-loop power control of the radio signal to the upper node received by the control signal processing unit 140.

The control unit 170 may perform a close loop power adjustment based on the closed-loop power control identification information.

Specifically, the control unit 170 may adjust the transmission power of the IAB-MT by performing power control using identification information of different closed loop power control depending on whether or not the IAB-MT and the IAB-DU transmit and receive at the same time, that is, whether the transmission and reception pattern (which may be read as the TDD pattern) of the child node transmits and receives DL or UL.

The control unit 170 may also explicitly or implicitly acquire information indicating a pattern of radio signal transmission and reception with the child node.

For example, the control unit 170 may acquire a transmit/receive pattern that is explicitly indicated by DCI or RRC signaling, or may implicitly acquire a transmit/receive pattern of a radio signal with a child node, depending on whether the slot or symbol transmitted by the IAB-MT is a DL or UL transmission. A specific acquisition example will be described later.

### (3) Operation of Radio Communication System

Next, the operation of radio communication system 10 will be described. More specifically, the operation related to the transmission power control in the IAB node, and more specifically, the UL power control of the IAB-MT will be described.

### (3.1) Issues

In multiplexing in the IAB, e.g., simultaneous transmission between the IAB-MT and the IAB-DU, the IAB-MT will perform transmission in a DL slot with the UE 200 (which may be read as a legacy UE).

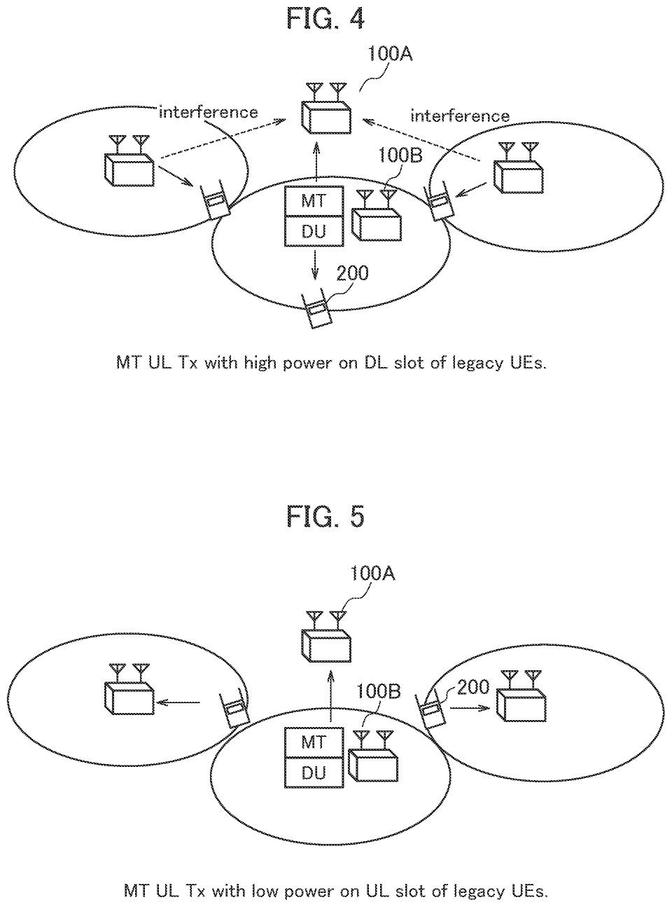

In this case, if the DL power is much higher than the UL power, a large interference occurs in the UL transmission. FIG. 4 shows an example of interference to UL transmission by DL transmission of the IAB-DU.

One solution to mitigate such interference is for the IAB-MT to perform UL transmissions with high power comparable to DL power (from gNB).

However, although the IAB-MT performs transmission on the UL slot with the legacy UE, it is necessary to perform UL transmission with a low power equivalent to that of the legacy UE in order to avoid interference with the legacy UE. FIG. 5 shows an example in which the IAB-MT performs UL transmission at low power.

Thus, the IAB-MT must perform UL transmissions with high or low power in different cases, i.e., in the DL/UL slots of the legacy UE, and it is desirable to be able to configure two sets (two) of UL power control parameters.

In order to realize such transmit power control, it is necessary to configure two sets of UL power control parameters for the IAB-MT. In particular, the transmission power control is aimed at reducing interference to UL transmission by DL transmission of the IAB-DU.

### (3.2) Operation Overview

As described above, when the IAB-MT and the IAB-DU perform simultaneous transmission, the transmission power of the IAB-DU is often higher than that of the IAB-MT, so that the radio signal from the IAB-DU interferes when the parent node receives the radio signal from the IAB-MT.

Therefore, in order to avoid interference from the IAB-DU in the parent node, it is possible to control the transmission power of the IAB-MT in consideration of the transmission power of the IAB-DU.

Specifically, the following operation examples may be included.
(Operation example 1): Setting and notification of UL power control (power control)
(Operation example 1-1): Setting different power control parameters
Configure two sets of power control parameters to IAB-MT
Switches the transmission power of the IAB-MT according to the UE's TDD pattern DL/UL.
(Operation example 1-2): Different close loop adjustment is calculated according to the TDD pattern of the UE.
(Option 1): Use a different closed loop index 1
   When using DCI format 2_2: explicitly notify the close loop index
   Using DCI format 0_0/0_1,1_0/1_1:
      (Alt.1)—Explicitly notify by adding a new notification bit
      (Alt.2): Implicit judgment using “Identifier for DCI formats” for DL/UL notification of IAB-MT
(Option 2): Use a new index (index x)
   Using DCI format 2_2: explicitly notify x
   Using DCI format 0_0/0_1,1_0/1_1:
      (Alt.1)—Explicitly notify by adding a new notification bit
      (Alt.2): Implicit judgment using “Identifier for DCI formats” for DL/UL notification of IAB-MT
(Operation example 2): Notification/setting method of DL/UL slot/symbol of UE
   (Explicit notification/setting)
      Notification by adding a new notification bit to the DCI format
      Setting in the same way as TDD pattern using RRC
   (Implicit notification/setting)
   IAB-MT slot/symbol determined by DL or UL
   Determined according to the setting of tdd-UL-DL-ConfigurationCommon
   If “symbol-IAB-MT=explicit-IAB-MT”, DL is determined (Since IAB-MT is UL-F-DL, the UL of IAB-MT can be assumed to be DL of IAB-DU.)
   If “symbol-IAB-MT=explicit”, UL is assumed (Since IAB-MT is also DL-F-UL, the UL of IAB-MT can be assumed to be the UL of IAB-DU.).
   When the slot format reported in DCI format 2_0 is 56-96, DL is determined (because IAB-MT is UL-F-DL).
   When the slot format reported in DCI format 2_0 is 1-55, it is judged as UL (because IAB-MT is also DL-F-UL).
   If configure to Flexible, consider DL or UL
   Configures DL or UL as the default value, for example, if not explicitly configured
(Operation example 3): IAB-MT Capability
   Reports whether or not the transmission power control of the IAB-MT is enabled according to the DL/UL of the Access UE.
(Modification example 1): Configure different parameters according to simultaneous duplexing between IAB-MT and IAB-DU.
(Modification example 2): If the UL transmission of IAB-MT corresponds to only UL slot/symbol, configure only one parameter.

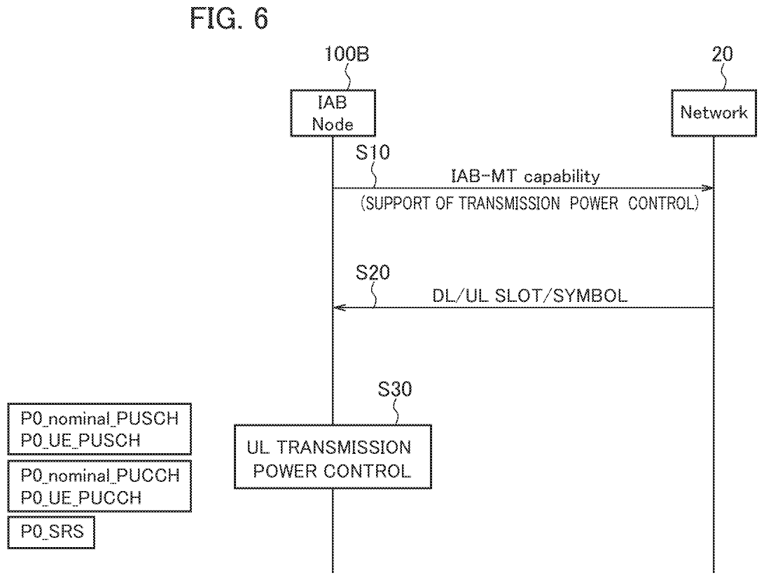

FIG. 6 shows an example of a communication sequence for UL power control of the IAB-MT. As shown in FIG. 6, the IAB node (radio communication node 100 B) transmits capability information (Capability) including whether or not the transmission power control of the IAB-MT is applicable to the network (NG-RAN 20) (S 10).

The network notifies the IAB node of the transmission/reception pattern of the radio signal of the child node (which may include the UE 200), specifically, the slot/symbol of the DL/UL (step 20).

The IAB node performs UL transmission power control according to the presence/absence of simultaneous transmission/reception between the IAB-MT and the IAB-DU, that is, the transmission/reception pattern (which may be read as the TDD pattern) of the child node (S 30). Specifically, as described above, the transmission power control may be executed by switching the power control parameter (P0_nominal_PUSCH, P0_UE_PUSCH, P0_nominal_PUCCH, P0_UE_PUCCH, P0_SRS), or the power control by the closed loop power control (close loop adjustment) may be executed based on the closed loop power control identification information of the radio signal to the upper node.

A specific operation example will be described below.

### (3.3) Operation Example 1

This operation example relates to UL power control of the IAB-MT using different power control parameters (operation example 1-1) and different closed loop power control identification information.

### (3.3.1) Example 1-1

In this operation example, two sets of power control parameters may be used. Specifically, the UL power of the IAB-MT may be switched using at least two of the power control parameters P0_nominal PUSCH, P0_UE_PUSCH, P0_nominal_PUCCH, P0_UE_PUCCH, and P0_SRS described above.

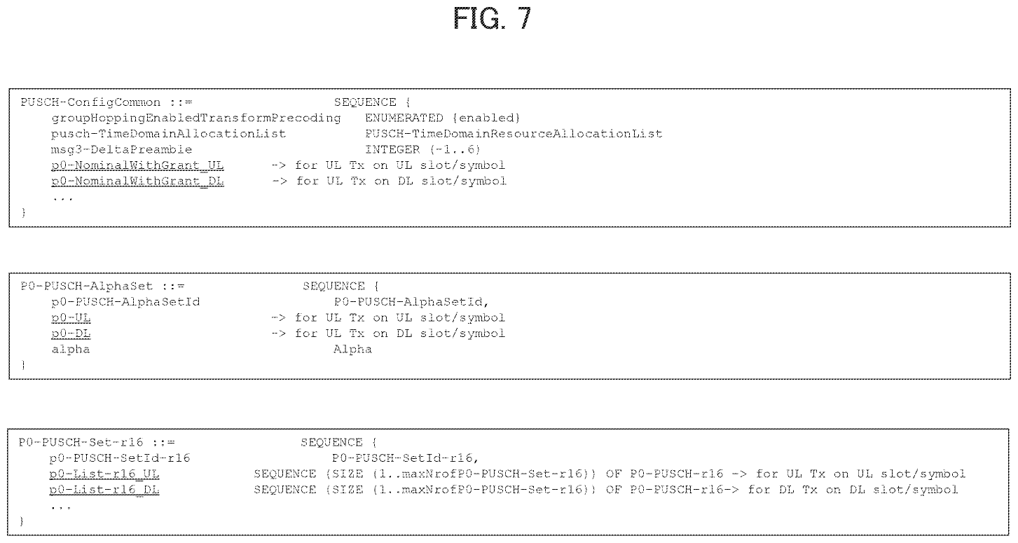

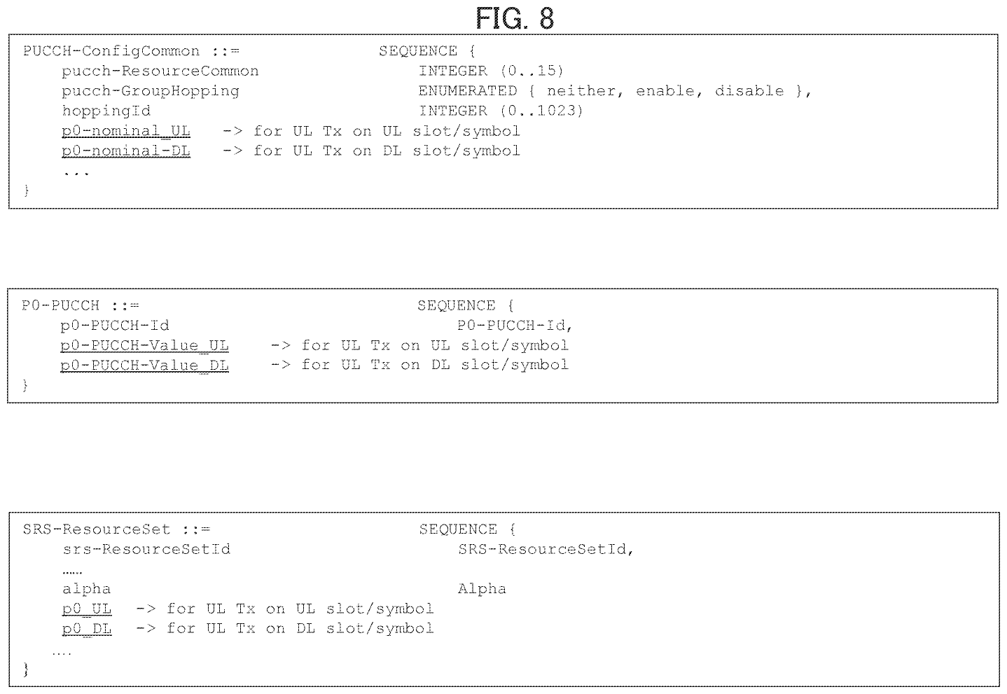

FIG. 7 shows a configuration example of PUSCH-ConfigCommon (part). FIG. 8 shows a configuration example of PUCCH-ConfigCommon (part). As shown in FIGS. 7 and 8, the two sets of power control parameters may be applied to the UL transmission of the IAB-MT on the DL slot/symbol and the UL slot/symbol, respectively. The DL/UL slot/symbol may refer to a DL/UL slot/symbol of a legacy UE. A method for determining that the slot/symbol is a DL or UL slot/symbol will be described in operation example 2, which will be described later.

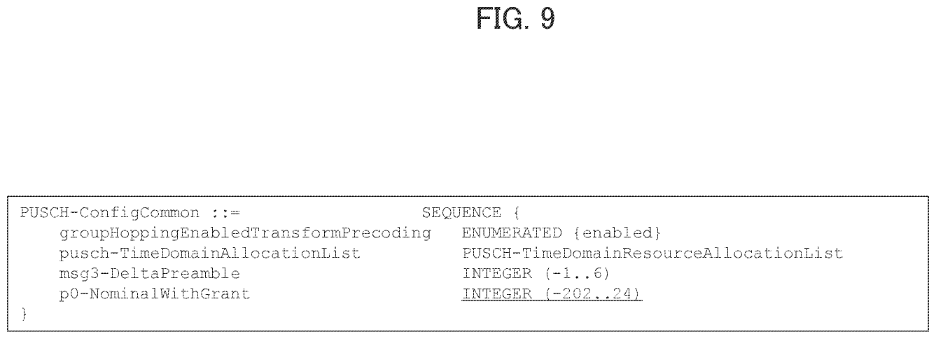

Considering that the IAB-MT can configure and indicate a UL transmission power higher than that of a conventional UE, the range of values of P0_nominal_PUSCH, P0_UE_PUSCH, P0_nominal_PUCCH, P0_UE_PUCCH, and P0_SRS in this operation example may be different from those in 3GPP Releases 15 and 16. FIG. 9 shows a configuration example of a part of PUSCH-ConfigCommon including p0-NominalWithGrant.

As shown in FIG. 9, the UL transmit power specified by p0-NominalWithGrant may be different from the range of 3GPP Release 15, 16 (INTEGER (−202 . . . 24)). For example, the range may be larger.

### (3.3.2) Example 1-2

In this operation example, different closed loop power control identification information (closed loop index) may be used.

For example, in the power control of the PUSCH, the following equation is used.

P_{0_PUSCH}=P_{0_Nominal_PUSCH}+P_{0_UE_PUSCH}

where P_{0_Nominal_PUSCH} is a cell-specific parameter provided by p0-NominalWithGrant. P_{0_UE_PUSCH is provided by P}0-PUSCH-AlphaSet and P0-PUSCH-Set.

In the PUSCH power control, f_{b , f, c} (i, l) is the power control adjustment state for the closed loop power control, and l is the closed loop index. More specifically, 1={0, 1} indicates that the UE is configured with (two) twoPUSCH-PC-AdjustmentStates, and 1=0 indicates that the UE is not configured with (two) twoPUSCH-PC-AdjustmentStates.

The following equation is used as the PUCCH power control.

P_{0_PUCCH}=P_{0_Nominal_PUCCH}+P_{0_UE_PUCCH}

Here, P_{0_Nominal_PUCCH} is a cell specific parameter provided by p0-Nominal. P_{0_UE_PUCCH} is provided by P0-PUCCH. Further, g_{b,f,c} (i, l) is a power control adjustment state for closed loop power control, and l is a closed loop index. 1={0, 1} indicates that the UE is configured with (two) twoPUCCH-PC-AdjustmentStates, and 1=0 indicates that the UE is not configured with (two) twoPUCCH-PC-AdjustmentStates.

In the Sounding Reference Signal (SRS) power control, P_{0_SRS} is provided by P0 of the SRS resource set setting.

In this operation example, different close loop adjustments may be calculated for the DL slot/symbol and the UL transmission of the IAB-MT on the UL slot/symbol.

Specifically, in the case of option 1, the power control adjustment state of PUSCH (f_{b,f,c} (i, l)) and the power control adjustment state of PUCCH (g_{b,f,c} (i, l)) may use different closed loop index 1 in DL or UL slots/symbols.

More specifically, if two PUSCH-PC-AdjustmentState or two PUCCH-PC-AdjustmentState is configured, l={0, 1} may be used for UL Tx on UL (or DL slots/symbols in IAB-MT, and l={2, 3} may be used for UL Tx on DL (or UL) slots/symbols in IAB-MT.

Also, if two PUSCH-PC-AdjustmentStates or two PUCCH-PC-AdjustmentStates is not configured, l=0 may be used for a UL Tx on UL (or DL) slot/symbol in IAB-MT, and l=1 may be used for a UL Tx on DL (or UL) slot/symbol in IAB-MT.

In the case of option 2, a new index such as “x” may be added to the power control adjustment state of PUSCH/PUCCH, and this may be f_{b,f,c} (i, l, x) or g_{b,f,c} (i, l, x).

x=0 may be used for the UL Tx of the IAB-MT on the UL (or DL) slot/symbol. x=1 may be used for the UL Tx of the IAB-MT on the DL (or UL) slot/symbol.

Here, the DL/UL slot may mean the DL/UL slot/symbol of the legacy UE. A method for determining that each slot is a DL/UL slot/symbol will be described later in Operation Example 2.

In the case of option 1, the DCI format used for transmitting the TPC commands for PUCCH and PUSCH, for example, DCI format 2_2, can explicitly indicate the closed loop index.

In the existing DCI format 2_2, if two PUSCH-PC-AdjustmentStates or two PUCCH-PC-AdjustmentStates are configured, the 1-bit closed loop indicator in DCI format 2_2 indicates the closed loop index; otherwise, the closed loop index is 0 bits.

If two PUSCH-PC-AdjustmentStates or two PUCCH-PC-AdjustmentStates are configured, the close-loop indicator may be increased to two bits.

On the other hand, if two PUSCH-PC-AdjustmentStates or two PUCCH-PC-AdjustmentStates are not configured, the closed loop indicator may be increased to one bit.

TPC commands in the DCI format of PDSCH scheduling and/or in the DCI format of PUSCH scheduling may be configured as follows.
(Alt.1): A new bit field of one bit may be used to indicate whether the TPC command applies to the DL slot/symbol, or to the closed-loop power control of the UL Tx of the IAB-MT on the UL slot/symbol. The applicability may be indicated by reusing or extending the existing bit field.
(Alt.2)—Implicitly determines the closed loop index. If the slot/symbol is a DL slot/symbol, the TPC command may apply to the closed loop power control of UL Tx of IAB-MT of DL slot/symbol, and if the slot is a UL slot/symbol, the TPC command may apply to the closed loop power control of UL Tx of IAB-MT of UL slot/symbol. The method of determining that the slot/symbol is a DL or UL slot/symbol will be described in operation example 2, which will be described later.

In the case of option 2, in the DCI format used to send the PUCCH and/or PUSCH TPC commands, for example, DCI format 2_2, one bit may be used to indicate “x”.

TPC commands in the DCI format of PDSCH scheduling and/or in the DCI format of PUSCH scheduling may be configured as follows.
(Alt.1): A new bit field of one bit may be used to indicate “x”. The applicability may be indicated by reusing or extending the existing bit field.
(Alt.2): Implicitly determines the closed loop index. If the slot/symbol is a DL slot/symbol, the TPC command may be applied to the closed-loop power control of the UL Tx power at the DL slot/symbol (i.e., x=1 (or 0)), and if the UL slot/symbol, the TPC command may be applied to the closed-loop power control of the UL Tx power at the UL slot/symbol (i.e., x=0 (or 1)). The method of determining that the slot/symbol is a DL or UL slot/symbol will be described in operation example 2, which will be described later.

Also, given that higher UL Tx power than legacy UEs can be configured and directed to the IAB-MT, values different from those in 3GPP releases 15 and 16 may be mapped to the TPC command fields (see Tables 1 and 2).

TABLE 1

| | Accumulated | Absolute |
|---|---|---|
| TPC Command | δ_{PUSCH, b, f, c} or δ_{SRS, b, f, c} | δ_{PUSCH, b, f, c} or δ_{SRS, b, f, c} |
| Field | [dB] | [dB] |
| 0 | −1 | −4 |
| 1 | 0 | −1 |
| 2 | 1 | 1 |
| 3 | 3 | 4 |

TABLE 2

| | Accumulated |
|---|---|
| TPC Command | δ_{PUCCH, b, f, c} |
| Field | [dB] |
| 0 | −1 |
| 1 | 0 |
| 2 | 1 |
| 3 | 3 |

Tables 1 and 2 are defined in 3GPP TS 38.213, Chapter 7.

### (3.4) Operation Example 2

This operation example relates to a method for notifying and setting a DL/UL slot/symbol of a UE (child node). To determine that the slot/symbol is to be utilized as a DL slot/symbol or a UL slot/symbol for a legacy UE, either of the following methods may be used.

One way is to explicitly notify and configure. Specifically, it may be explicitly indicated by a new bit field of one bit in the DCI.

Note that an existing bit field may be reused. For example, in the operation example 1-2 described above, 1 bit may be used to indicate closed loop power control for a DL or UL slot/symbol and may be reused to determine whether a power control parameter (e.g., PO) for a DL or UL slot/symbol is applied.

Alternatively, it may be explicitly configured by RRC signaling such as tdd-UL-DL-ConfigurationCommon, tdd-UL-DL-ConfigurationDedicated, tdd-UL-DL-ConfigurationDedicated-IAB-MT (see 3GPP TS 38.331), or it may be explicitly configured by DCI such as DCI format 2_0.

Another method is implicit notification/setting. For example, if the slot/symbol is configured as DL/UL by tdd-UL-DL-Configuration Common, the slot/symbol may be determined as DL/UL.

If symbol-IAB-MT=explicit-IAB-MT is configured by tdd-UL-DL-ConfigurationDedicated-IAB-MT, the slot/symbol may be determined as DL. If symbol-IAB-MT=explicit-IAB-MT is configured, the first nrofUplinkSymbols symbol in the slot is UL of IAB-MT. However, legacy UE cannot be configured or specified in slot format beginning with the UL symbol. Thus, this type of slot/symbol may be determined as the DL slot/symbol of the legacy UE.

If symbol-IAB-MT=explicit is configured by tdd-UL-DL-ConfigurationDedicated-IAB-MT, the slot/symbol may be determined to be UL.

If the slot/symbol is shown in slot format 56-96 of 3GPP TS 38.213 Chapter 14 (see Table 14-2) in DCI format 2_0, the slot/symbol may be determined as DL. These slot formats begin with the UL symbol, but legacy UE cannot be configured or specified in slot formats that begin with the UL symbol. Thus, this type of slot/symbol may be determined as the DL slot/symbol of the legacy UE.

If the slot/symbol is shown in DCI format 2_0 as slot format 1-55 of 3GPP TS 38.213 Chapter 11 (see Table 11.1.1-1), the slot/symbol may be determined as UL.

Alternatively, if the slot/symbol is configured and indicated as Flexible by tdd-UL-DL-ConfigCommon and/or tdd-UL-ConfigDedicated-IAB-MT/DCI format 2_0, the slot/symbol may be determined as DL (or UL).

The slot/symbol may also be determined as DL (or UL) by default if it is not explicitly configured or indicated, or if a particular rule cannot be applied.

If the slot/symbol is determined to be DL by the method described above, the IAB-MT may apply UL power control in the DL slot illustrated in Operation Example 1. If the slot/symbol is determined to be UL, the IAB-MT may apply UL power control to the UL slot illustrated in Operation example 1.

### (3.5) Operation Example 3

This operational example relates to notification of the capability of the IAB-MT, specifically, the capability of UL power control of the IAB-MT.

The UE capability information that informs the IAB-MT of this capability may indicate whether different power control parameters are supported for the UL transmission of the IAB-MT on DL and UL slots. The above-described operation may only be applied if the IAB node (radio communication node 100 B) reports the capability and/or is configured by upper layer (e.g., RRC) signaling.

### (3.6) Modifications

The operation example described above may be changed as follows. For example, different sets of transmit power control parameters and/or different closed-loop power controls may be configured and instructed for four cases (Modified Example 1).
Simultaneous transmission in DL slots
No simultaneous transmissions in DL Slots
Simultaneous transmission in UL slots
No simultaneous transmissions in UL slots

The DL/UL slot/symbol here refers to the DL/UL slot/symbol of the legacy UE. The method for determining whether the slot is a DL or a UL slot/symbol may be in accordance with operation example 2.

Alternatively, the UL transmission of the IAB-MT may be supported only in the UL slot/symbol (modification example 2). That is, the slot format indicated by tdd-UL-DL-configurationDedicated-IAB-MT and/or DCI format 2_0 need not override the DL slot/symbol configured by tdd-UL-DL-configurationCommon. In this case, only one set of power control parameters may be used (As with 3GPP Releases 15, 16).

### (4) Operational Effects

According to the embodiment described above, the following effects are obtained. Specifically, an IAB node (radio communication node 100 B) receives (P0_ nominal_PUSCH, P0_UE_PUSCH, etc.) a plurality of control parameters of transmission power (UL transmission power) of a radio signal to an upper node (parent node), and can control UL transmission power using any control parameter based on a transmission/reception pattern (TDD pattern, etc.) of the radio signal with a child node (radio communication node 100 C or UE 200).

Further, the IAB node receives a plurality of closed loop power control identification information (closed loop index) of the radio signal to the upper node, and can execute the closed loop power control associated with any identification information based on the transmission/reception pattern of the radio signal with the child node.

Therefore, even when the IAB-MT and the IAB-DU perform transmission at the same time, when the parent node (radio communication node 100 A) receives a radio signal transmitted from the IAB-MT, the possibility that the radio signal transmitted from the IAB-DU causes interference can be avoided. That is, according to radio communication system 10, interference from the IAB-DU at the parent node can be reliably avoided.

In this embodiment, the IAB node can explicitly or implicitly acquire information indicating a transmission/reception pattern of a radio signal with a child node. Therefore, the IAB-MT can more reliably avoid the possibility that the radio signal transmitted from the IAB-DU will cause interference based on the transmission/reception pattern.

In this embodiment, the IAB node can transmit to the network UE capability information indicating the capability to control the UL transmission power. Thus, the network may apply power control settings that take into account the ability of the IAB node to control UL transmit power.

### (5) Other Embodiments

Although the embodiment has been described above, it is obvious to those skilled in the art that various modifications and improvements are possible without being limited to the description of the embodiment.

For example, in the above-described embodiment, an example in which P0_ nominal_PUSCH, P0_UE_PUSCH, P0_nominal_PUCCH, P0_UE_PUCCH, and P0_SRS are used as control parameters of the UL transmission power of the IAB-MT has been described, but only a part of these control parameters, for example, for PUSCH or for PUCCH, may be used.

In the above-described embodiment, the names of the parent node, the IAB node, and the child node are used, but the names may be different as long as a configuration of a radio communication node in which a radio backhaul between radio communication nodes such as gNB and radio access with a terminal are integrated is adopted. For example, it may be simply referred to as a first node, a second node, or the like, or it may be referred to as an upper node, a lower node, a relay node, an intermediate node, or the like.

Further, the radio communication node may be referred to simply as a communication device or communication node, or may be read as a radio base station.

The block configuration diagram (FIG. 3) used for the description of the above-described embodiment shows blocks in units of functions. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmission is called a transmission unit (transmitting unit) or a transmitter. As described above, there is no particular limitation on the method of implementation.

Further, the above-described radio communication nodes 100 A to 100 C (the apparatus) may function as a computer that performs processing of the radio communication method of the present disclosure. FIG. 10 is a diagram showing an example of a hardware configuration of the apparatus. As shown in FIG. 10, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 3) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 operates, for example, an operating system to control the entire computer. Processor 1001 may comprise a central processing unit (CPU) including interfaces to peripheral devices, controllers, arithmetic units, registers, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, or the like. The memory 1002 may store programs (program codes), software modules, and the like that are capable of executing the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Devices such as the processor 1001 and the memory 1002 are connected by a bus 1007 for communicating information. The bus 1007 may be configured using a single bus or may be configured using different buses for each device.

In addition, the device may comprise hardware such as a microprocessor, a digital signal processor (DSP), an application specific integrated circuit (ASIC), a programmable logic device (PLD), a field programmable gate array (FPGA), and the hardware may implement some or all of each functional block. For example, the processor 1001 may be implemented by using at least one of these hardware.

Further, the notification of the information is not limited to the mode/embodiment described in the present disclosure, and other methods may be used. For example, notification of information may be performed by physical layer signaling (e.g., Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or a combination thereof. The RRC signaling may also be referred to as an RRC message, for example, an RRC Connection Setup message, an RRC Connection Reconfiguration message, and the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, and the like of each aspect/embodiment described in the present disclosure may be changed in order as long as there is no contradiction. For example, the methods described in this disclosure use an exemplary sequence to present the elements of the various steps and are not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched over in accordance with implementation. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and the symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, planes, etc.), an unmanned mobile body (Drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal). For example, each aspect/embodiment of the present disclosure may be applied to a configuration in which communication between a base station and a mobile station is replaced with communication between a plurality of mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”.). For example, terms an uplink channel, a downlink channel, or the like may be read as a side channel.

Similarly, the mobile station in the present disclosure may be read as a base station. In this case, the base station may have the function of the mobile station. A radio frame may be composed of one or more frames in the time domain. Each frame or frames in the time domain may be referred to as a subframe. A subframe may be further configured by one or more slots in the time domain. The subframe may be a fixed time length (For example, 1 ms) independent of the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the sub-frame and TTI may be a sub-frame (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (minislot number) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “decision” may include regarding some action as “judgment” or “decision”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
100 A, 100 B, 100 C radio communication nodes
110 radio signal transmission and reception unit
120 amplifier unit
130 modulation and demodulation unit
140 control signal processing unit
150 encoding/decoding unit
160 data transmission and reception unit
170 control unit
200 UE
C1, C2, and C3 cells
1001 processor
1002 memory
1003 storage
1004 communication device
1005 input device
1006 output device
1007 bus

1. A radio communication node comprising:
a reception unit that receives a plurality of control parameters of transmission power of a radio signal to an upper node; and
a control unit that controls the transmission power using any of the control parameters based on a transmission/reception pattern of a radio signal with a child node.

2. A radio communication node comprising:
a reception unit that receives a plurality of identification information for closed-loop power control of a radio signal to an upper node; and
a control unit that executes the closed-loop power control associated with any of the identification information based on a transmission/reception pattern of a radio signal with a child node.

3. The radio communication node of claim 1, wherein the control unit acquires information indicating the transmit/receive pattern, either explicitly or implicitly.

4. The radio communication node of claim 1, further comprising a transmission unit that transmits capability information indicating capability to control of the transmission power.

5. The radio communication node of claim 2, further comprising a transmission unit that transmits capability information indicating capability to the closed loop power control.
